(19) United States
(12) Patent Application Publication
(10) Pub. No.: US 2016/0207788 A1
(43) Pub. Date: Jul. 21, 2016

(54) REDISPERSIBLE MAGNESIUM HYDROXIDE AND A PROCESS FOR MANUFACTURING THE SAME

(71) Applicant: TATA CHEMICALS LIMITED, Mumbai (IN)

(72) Inventors: Sachin Parashar, Pune (IN); Sachin Pratap Lalbegi, Pune (IN)

(73) Assignee: TATA CHEMICALS LIMITED, Mumbai (IN)

(21) Appl. No.: 14/783,059

(22) PCT Filed: Dec. 23, 2013
(86) PCT No.: PCT/IN2013/000797

§ 371 Date: Oct. 7, 2015

(30) Foreign Application Priority Data
Apr. 8, 2013 (IN) 1331/MUM/2013

(51) Int. Cl. C01F 5/14

(52) U.S. Cl. CPC C01F 5/14; C01P 2004/64; C01P 2004/62

(57) ABSTRACT

A redispersible magnesium hydroxide is disclosed. The redispersible magnesium hydroxide comprises of magnesium hydroxide particles coated with at least one capping agent wherein the capping agent having a critical micellar concentration value of not more than 0.15% the redispersible magnesium hydroxide having a size in the range of 5 nm to 500 nm.

The present disclosure generally relates to a redispersible magnesium hydroxide. The disclosure also relates to a process for manufacturing a redispersible magnesium hydroxide.

### BACKGROUND OF INVENTION

Magnesium hydroxide {Mg(OH)₂} is a widely used alkali compound in chemical industry and has major applications as a fire retardant, a toothpaste additive and as an acid neutralizer. Magnesium hydroxide is also used as a pigment in the paper industry. It also works as an active ingredient in antacid formulations.

It is desirable that magnesium hydroxide be easily transported in a ready to use state. Traditionally, magnesium hydroxide is transported in the form of a slurry or as cakes. The most economical way to transport magnesium hydroxide is in a dry powder form. However, the finely pulverized particles do not completely recover their original size. Moreover, aggregation of particles and reduction in the surface activity results in a higher tendency towards sedimentation and lower reactivity.

There have been several efforts to address the issues of stable dispersion of magnesium hydroxide. These approaches have been focused on stabilizing the slurry or making cakes having specific moisture content. A major disadvantage with the slurry is that it is fairly unstable and requires the higher maintenance for proper moisture retention and higher volume transport burden.

The U.S. Pat. No. 58,72,169 of Elsner, et al. describes the flame retardant quality magnesium hydroxide having a BET surface area of less than approximately 10 m² per gram (uncoated), an average particle size of approximately 0.5 to 10.0 micron, and less than approximately 0.5% of particles over 10 micron (average particle size measured by laserlight scattering method). The invention further discloses the magnesium hydroxide is coated with a surface active agent, preferably a fatty acid surface active agent. The invention does not address the redispersibility of the magnesium hydroxide particles.

The U.S. patent application Ser. No. 06/641,529 of Zupanovich et al. discloses an aqueous stable magnesium hydroxide suspension which is dispersible in oil using an alkyl benzene sulfonate emulsifier. The invention mainly focuses on slurry or paste.

Robert Crouse Mahar in U.S. Patent application Ser. No. 07/956,529 filed in 1992 claims aqueous magnesium hydroxide slurry prepared with a combination of (a) one or more polymeric dispersants and (b) one or more water-soluble alkali metal salts. Slurries prepared according to the invention are less susceptible to increases in viscosity upon standing and remain flowable after several days.

The Japanese application number 318364, filed in 1998 (JP2000128526) discloses the magnesium hydroxide cake having specific moisture content to obtain redispersibility from the cake. However, as the transport and storage of such magnesium hydroxide cake requires maintenance of specific moisture conditions to get dispersibility; such cakes are not economically viable for commercial use.

Therefore there is a need for redispersible magnesium hydroxide which can be easily transported and stored with minimum requirements.

### SUMMARY OF INVENTION

A redispersible magnesium hydroxide is disclosed. The redispersible magnesium hydroxide comprises of magnesium hydroxide particles coated with at least one capping agent wherein the capping agent having a critical micellar concentration value of not more than 0.15% the redispersible magnesium hydroxide having a size in the range of 5 nm to 500 nm.

A process for manufacturing redispersable magnesium hydroxide is also disclosed. The process comprises preparing an aqueous solution of magnesium hydroxide precursor, adding a capping agent to the aqueous solution of magnesium hydroxide precursor to obtain a mixture, adding an aqueous solution of alkali to the mixture to precipitate redispersable magnesium hydroxide. The process further comprises the separating and drying the redispersable magnesium hydroxide.

### BRIEF DESCRIPTION OF THE DRAWINGS

The accompanying drawing illustrates the exemplary embodiments and together with the following detailed description serves to explain the principles of the process.

FIG. 1 illustrates particle size distribution of the magnesium hydroxide in 0.36% w/w dispersion in water produced by the disclosed process.

FIG. 2 illustrates the zeta potential distribution of 0.36% w/w dispersion of the magnesium hydroxide produced by the proposed process in water.

FIG. 3 illustrates the particle size distribution of the magnesium hydroxide particles in 1% w/w dispersion in water produced by the disclosed process.

FIG. 4 illustrates the zeta potential distribution of 1% w/w dispersion of magnesium hydroxide produced by the disclosed process in water.

### DETAILED DESCRIPTION

For the purpose of promoting an understanding of the principles of the invention, reference will now be made to embodiments and specific language will be used to describe the same. It will nevertheless be understood that no limitation of the scope of the invention is thereby intended, such alterations and further modifications in the disclosed process, and such further applications of the principles of the invention therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “one embodiment” “an embodiment” or similar language means that a particular feature, structure, or characteristic described in connection with the embodiment is included in at least one embodiment of the present invention. Thus, appearances of the phrase “in one embodiment”, “in an embodiment” and similar language throughout this specification may, but do not necessarily, all refer to the same embodiment.

The present disclosure provides a redispersible magnesium hydroxide.

The term “redispersible magnesium hydroxide” refers to magnesium hydroxide that is redispersible in an aqueous solvent, an organic solvent or a polymeric solvent.

The redispersibility of the magnesium hydroxide ranges from 0.01% w/w to 50.0% w/w of solvent. Preferably, the redispersibility of the magnesium hydroxide is 0.01% w/w to 30.0% w/w.

The present disclosure provides a redispersible magnesium hydroxide The redispersible magnesium hydroxide comprises magnesium hydroxide particles coated with at least one capping agent, the capping agent having a critical micellar concentration value of not more than 0.15% the redispersible magnesium hydroxide having a size in the range of 5 nm to 500 nm.

In accordance with an aspect, the capping agent includes any chemical compound having critical micellar concentration (CMC) value of at least 0.15%.

In accordance with a preferred embodiment, the capping agent has a critical micellar concentration value of at least 0.10%. Most preferably the capping agent has a critical micellar concentration at least 0.05%.

In accordance with an embodiment the capping agent is a surfactant. The surfactant may be a non-ionic surfactant, an anionic surfactant, a cationic surfactant, an amphoteric surfactant or a mixture thereof. The capping agent include but are not limited to esters of fatty acids, sulfosuccinate esters, sulfosuccinamate esters, polyacrylates or salts of polyacrlates, alkyl ammonium salts, organo-sulphate or their combinations.

In accordance with an alternate embodiment of the invention the surfactant is food grade surfactant.

The amount of capping agent ranges from 30% to 60% with respect to magnesium hydroxide particles.

In accordance with an aspect, the zeta potential of magnesium hydroxide dispersion is in the range from 30 to 50 mV.

In an aspect of the invention the redispersible magnesium hydroxide is in powder form and having the minimum moisture content under ambient conditions. In a preferred aspect of the invention the powder is having the moisture content is about 2.0% or less and preferably less than 0.5%.

A process for manufacturing redispersible magnesium hydroxide is also disclosed. The process comprises of preparing an aqueous solution of a magnesium hydroxide precursor, adding a capping agent to the aqueous solution of the magnesium hydroxide precursor to obtain a mixture and adding an aqueous solution of an alkali to the mixture to precipitate redispersable magnesium hydroxide. The process further comprises of separating the precipitated redispersable magnesium hydroxide and drying the separated redispersable magnesium hydroxide.

In accordance with an aspect, after the addition of the aqueous solution of alkali the mixture is stirred.

In accordance with an aspect, after the addition of the aqueous solution of alkali the mixture is allowed to stand at a predetermined temperature for a predetermined time period to ensure the completion of reaction. In accordance with an embodiment, the mixture is allowed to stand for about 30 mins at a temperature of 30 degree C.

In accordance with an aspect, the magnesium hydroxide precursor is salt of the magnesium. By way of an example the magnesium salt is selected from but not limited to magnesium chloride, magnesium sulphate, magnesium nitrate, magnesium oxide or an ore containing magnesium.

In accordance with an aspect, the molar concentration of the magnesium hydroxide precursor in the aqueous solution of magnesium hydroxide is in the range from 0.001 mM to 3 M.

In accordance with an aspect, the capping agent has a critical micellar concentration value of not more than 0.15%. Preferably the capping agent has a critical micellar concentration value of not more than 0.10% and most preferably not more than 0.05%.

In accordance with an aspect the capping agent is a surfactant. The capping agent is selected from but is not limited to esters of fatty acids, sulfosuccinate esters, sulfosuccinamate esters, polyacrylates or salts of polyacrlates, alkyl ammonium salts, organo-sulphate or combinations thereof.

In accordance with an aspect, the amount of capping agent ranges from 1 to 10% of molar concentration of the magnesium ions present in the precursor.

In accordance with an aspect, the capping agent may be dissolved in a solvent. In accordance with an aspect the capping agent is dissolved in water or alcohol or mixture thereof.

The alkali may be any suitable alkali including but not limited to Sodium hydroxide, potassium hydroxide or ammonium hydroxide.

In accordance with an aspect, the concentration of the alkali ranges from 0.001 mM to 6 M. The schematic reaction formula is as follow:

Mg⁺²+2 OH⁻→Mg(OH)₂+Salt

In accordance with an aspect, the redispersable magnesium hydroxide is separated using any known technique including but not limited to decantation, filtration and centrifugation.

In accordance with an aspect, the separated redispersable magnesium hydroxide are dried in an oven under vacuum.

In an aspect of the invention the dried particles are in powder form and having the minimum moisture content under ambient conditions. In a preferred aspect of the invention the powder is having the moisture content is about 2.0% or less and preferably less than 0.5%.

### Example 1

813.24 grams of MgCl₂·6 H₂O was dissolved in 4 litres of water in a flask to obtain aqueous solution of magnesium hydroxide precursor. 320 grams of NaOH was dissolved in 4 litres of water, to obtain aqueous solution of alkali in a separate flask. 116.62 grams of sodium cetyltrimethylammonium bromide (CTAB) having CMC value 0.00092%, was added to the aqueous solution of magnesium hydroxide precursor to obtain a mixture. The aqueous solution of alkali was slowly added to the mixture over a predetermined period of time to precipitate redispersable magnesium hydroxide. After the addition was complete, the mixture was stirred for some more time. The precipitated redispersable magnesium hydroxide is separated by centrifugation followed by drying in oven under vacuum at appropriate temperature to obtain the redispersible magnesium hydroxide.

### Example 2

2033 grams of MgCl₂·6 H₂O was dissolved in 10 litres of water in a flask to obtain first solution of magnesium hydroxide precursor. 800 grams of NaOH was dissolved in 10 litres of water, to obtain the second solution of alkali in a separate flask. 116.62 grams of sodium dioctyl sulfosuccinate (75% w/w dispersed in water and ethanol) having CMC value 0.05%, was added to the aqueous solution of magnesium hydroxide precursor to obtain a mixture. The aqueous solution of alkali was slowly added to the mixture over a predetermined period of time to precipitate redispersable magnesium hydroxide. After the addition was complete, the mixture was stirred for some more time. The precipitated redispersable magnesium hydroxide is separated by centrifugation followed by drying in oven under vacuum at appropriate temperature to obtain the redispersible magnesium hydroxide.

### Example 3

2033 grams of MgCl₂·6 H₂O was dissolved in 10 litres of water in a flask to obtain aqueous solution of magnesium hydroxide precursor. 800 grams of NaOH was dissolved in 10 litres of water, to obtain aqueous solution of alkali in a separate flask. 417.88grams of sodium dioctyl sulfosuccinate (85% w/w dispersed in water) having CMC value 0.02%, was added to the aqueous solution of magnesium hydroxide precursor to obtain a mixture. The aqueous solution of alkali was slowly added to the mixture over a predetermined period of time to precipitate redispersable magnesium hydroxide. After the addition was complete, the mixture was stirred for some more time. The precipitated redispersable magnesium hydroxide is separated by centrifugation followed by drying in oven under vacuum at appropriate temperature to obtain the redispersible magnesium hydroxide.

### Example 4

985.92 grams of MgSO₄·7 H₂O was dissolved in 4 litres of water in a flask to obtain aqueous solution of magnesium hydroxide precursor. 320 grams of NaOH was dissolved in 4 litres of water, to obtain aqueous solution of alkali in a separate flask. 167.15 grams of sodium dioctyl sulfosuccinate (85% w/w dispersed in water) having CMC value 0.02%, was added to the aqueous solution of magnesium hydroxide precursor to obtain a mixture. The aqueous solution of alkali was slowly added to the mixture over a predetermined period of time to precipitate redispersable magnesium hydroxide. After the addition was complete, the mixture was stirred for some more time. The precipitated redispersable magnesium hydroxide is separated by centrifugation followed by drying in oven under vacuum at appropriate temperature to obtain the redispersible magnesium hydroxide.

### Example 5

203.30 grams of MgCl₂·6 H₂O was dissolved in 1 litre of water in a flask to obtain aqueous solution of magnesium hydroxide precursor. 80 grams of NaOH was dissolved in 1 litre of water, to obtain aqueous solution of alkali in a separate flask. 42.79 grams of sodium dioctyl sulphosuccinate (85% w/w dispersed in water) having CMC value 0.02%, was added to the aqueous solution of magnesium hydroxide precursor to obtain a mixture. The aqueous solution of alkali was slowly added to the mixture over a predetermined period of time to precipitate redispersable magnesium hydroxide. After the addition was complete, the mixture was stirred for some more time. The precipitated redispersable magnesium hydroxide is separated by centrifugation followed by drying in oven under vacuum at appropriate temperature to obtain the redispersible magnesium hydroxide.

### Example 6

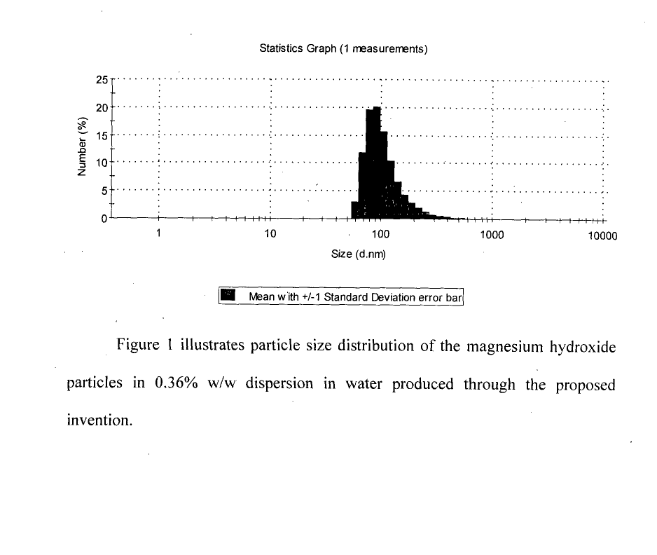

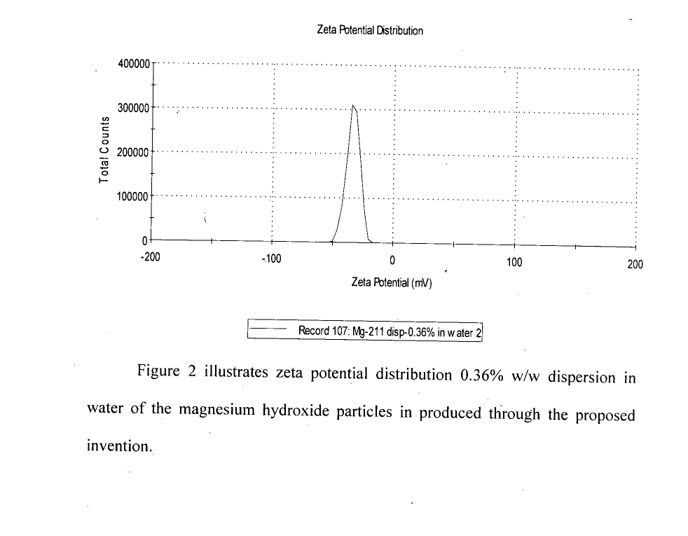

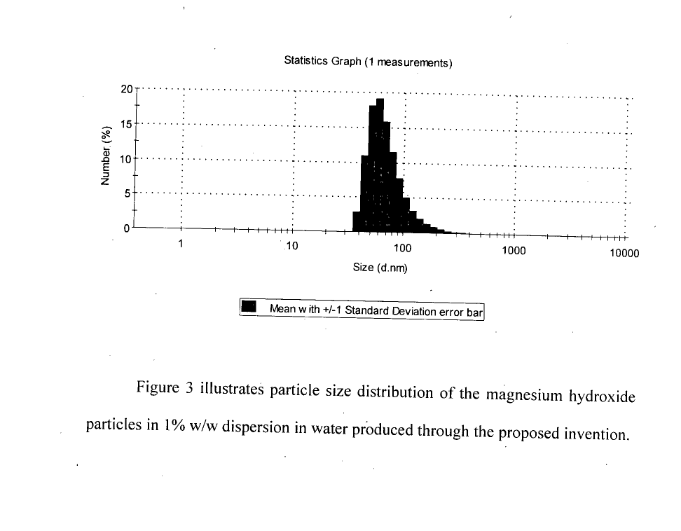

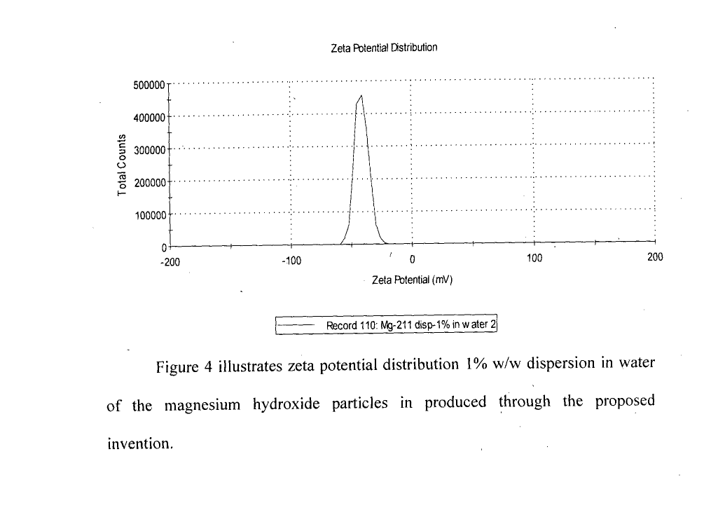

The zeta potential was measured by making aqueous dispersion of redispersible magnesium hydroxide using Malvern Zetasizer™. The aqueous dispersion of varying concentration of redispersible magnesium hydroxide obtained from the example 5 were made and the dispersion properties have been shown in table 1 and in FIGS. 1-4.

TABLE 1

| | % of | Average | Zeta | Standard |
|---|---|---|---|---|
| S. | Mg(OH)2 | Particle size | potential | deviation of zeta |
| No. | (w/w) | (nm) | (mV) | potential (mV) |
| 1 | 0.36 | 151.11 | −33.5 | 5.39 |
| 2 | 1 | 154.97 | −41.1 | 5.69 |

### INDUSTRIAL APPLICABILITY

Magnesium hydroxide is extensively being used as a fire retardant, basicity provider in paper industry and as antacid in pharmaceutical industry. With more stringent environmental norms, magnesium hydroxide particles are becoming the preferred choice of material in several industrial applications. Magnesium hydroxide has extensively replaced halogen, phosphorus and aluminum hydroxide based fire retardants in polymer and plastic applications as they are non toxic and can be processed at high temperatures. Advantages of better pulp yield, reduced yellowing etc are also possible with the use of magnesium hydroxide in paper and pulp industry. In order to have an effective delivery of the properties of magnesium hydroxide, one needs to disperse this material into various matrices like water, solvent or polymer as required for the end application. Dispersibility of such ceramic powders is challenging. The magnesium hydroxide coated with capping agent having a specific critical micellar concentration as disclosed in the invention, solves the issue of dispersibility and help to achieve the required effect in industrial applications.

We claim:

1. A redispersible magnesium hydroxide comprising:
magnesium hydroxide particles coated with at least one capping agent, the capping agent having a critical micellar concentration value of not more than 0.15%, the redispersible magnesium hydroxide having a size in the range of 5 nm to 500 nm.

2. A process as claimed in claim 1, wherein the capping agent has a critical micellar concentration value of not more than 0.05%.

3. A redispersible magnesium hydroxide as claimed in claim 1, wherein the amount of capping agent ranges from 30% to 60% of the magnesium hydroxide particles.

4. A redispersible magnesium hydroxide as claimed in claim 1, wherein the capping agent is selected from an ionic surfactant, a non-ionic surfactant and an amphoteric surfactant.

5. A redispersible magnesium hydroxide as claimed in claim 1, is in powder form and having moisture content about less than 2.0% and preferably less than 0.5%.

6. A process for manufacturing redispersable magnesium hydroxide comprising:
preparing an aqueous solution of magnesium hydroxide precursor;
adding a capping agent to the aqueous solution of magnesium hydroxide precursor to obtain a mixture;
adding an aqueous solution of alkali to the mixture to precipitate redispersable magnesium hydroxide;
separating and drying the redispersable magnesium hydroxide.

7. A process as claimed in claim 6, wherein the capping agent has a critical micellar concentration value of not more than 0.15%.

8. A process as claimed in claim 6, wherein the capping agent has a preferred critical micellar concentration value of not more than 0.05%.

9. A process as claimed in claim 6, wherein the capping agent is selected from an ionic surfactant, a non-ionic surfactant and an amphoteric surfactant.

10. A process as claimed in claim 6, wherein amount of capping agent ranges from 30% to 60% (w/w) with respect to magnesium hydroxide. cm 11. The process as claimed in claim 6, wherein the magnesium hydroxide precursor is any one of magnesium chloride, magnesium sulphate, magnesium nitrate or magnesium oxide.

12. The process as claimed in claim 6, wherein the molar concentration of the magnesium hydroxide precursor in the aqueous solution of magnesium hydroxide precursor is in the range of 0.001 mM to 3 M.

13. The process as claimed in claim 6, wherein the alkali is selected from sodium hydroxide, potassium hydroxide and ammonium hydroxide.

14. The process as claimed in claim 6, wherein the molar concentration of the alkali ranges from 0.001 mM to 6 M.

15. The process as claimed in claim 6, wherein the obtained dried particle in powder form and having moisture content about less than 2.0% and preferably less than 0.5%.
